(19) United States
(12) Patent Application Publication
(10) Pub. No.: US 2004/0024704 A1
(43) Pub. Date: Feb. 5, 2004

(54) Method and device for bill account by on-line certified contract

(76) Inventors: Dong Lyun Yim, Seoul (KR); Bok Sun Hwang, Seoul (KR); Sang In Lee, Seoul (KR); Byung Hwa Shim, Kyunggi-do (KR)

Correspondence Address: Thomas J D'Amico, Dickstein Shapiro Morin & Oshinsky, 2101 L Street NW, Washington, DC, 20037-1526, US

(21) Appl. No.: 10/344,094

(22) PCT Filed: Aug. 6, 2001
(86) PCT No.: PCT/KR01/01340

(30) Foreign Application Priority Data
Aug. 11, 2000 (KR) 2000-47646

(51) Int. Cl. G06F 17/60

(52) U.S. Cl. 705/40; 705/39

(57) ABSTRACT

The present invention relates to the method and device through which, for the purpose of a purchasing companies making payments for goods, services or construction services of a transaction partner: (1) an account receivable transfer contract between a financial institution and the purchasing company is certified and authenticated by a certified electronic authentication institution based upon the details of the account receivable that the purchasing company transmits via the telecommunication network, which account receivable is to be used as collateral and (2) the amount equivalent to the amount of the account receivable is provided to the transaction partner by the virtue of the loan provided until the due date of the account receivable (which is the conventional bill maturity date) based upon the said certified and authenticated account receivable transfer contract.

### TECHNICAL FIELD

The present invention relates to the method and device for payment of accounts receivable through the on-line authenticated account transfer agreement. According to the present invention, if a purchasing company needs to make a payment for goods, services or construction services of a transaction partner, the payment may be made in cash rather than by bills through the loan provided for collateral based upon an account transfer agreement between a financial institution such as a bank authenticated by a certified electronic authentication institution (the “financial Institution”) and the transaction partner.

### BACKGROUND ART

Currently, companies generally use bill payment methods to make payments for goods, services or construction services provided by transaction partners. Due to the indiscreet abuse of the bill payment methods, bills have been frequently dishonored. Especially during the time of the financial crisis in Asia, the incidents of bankruptcy due to the abuse of bills rapidly increased in number, causing unavoidable chain bankruptcy in some cases.

In order to overcome the problems with such bill payment methods, the following payment methods have been adopted and used: (1) A financial institution executes an account transfer agreement with a transaction partner of a purchasing company, under which the transaction partner transfers all of its future accounts receivable against the purchasing company to the financial institution and in the event that the transaction partner provides goods or services to the purchasing company and thus that certain accounts receivable are owed to the purchasing company, the financial institution receives the accounts receivable statements from the purchasing company and then provides loans to the transaction partner based upon the said accounts receivable statements; or (2) in the event that certain accounts receivable arise by a transaction partner's provision of goods or services to the purchasing company without execution of any general account transfer agreement, an account transfer agreement is executed off-line between a financial institution and the transaction partner regarding such owed accounts receivable and the financial institution provides loans to the transaction partner on the security of such accounts receivable. Then, on the date when the accounts receivable are due, the financial institution collects the amount of the relevant accounts receivable from the said purchasing company, thus, getting the repayment of the loans provided to the transaction partner.

The aforementioned purchase price payment methods are the methods by which the cash in the amount of the purchase price is loaned to the transaction partner on the security of the accounts receivable for the purchase price. In other words, a financial institution receives from the purchasing company the statement of the accounts receivable of the transaction partner through the telecommunication network, has the said accounts receivable confirmed by the transaction partner and then provides the loan for the purchase price to the transaction partner after receiving the purchase price payment request from the purchasing company.

However, the former method described above has problems in that the accounts receivable arising for services or construction services, other than the accounts receivable arising out of the sale of goods, may not be used as the security for the transfer agreement because there is a high possibility that the general account transfer agreement regarding the consideration for service provision or for construction service will be invalid. On the other hand, the latter method described above may delay the process and increase the workload because account transfer agreements must be executed off-line.

### DISCLOSURE OF THE INVENTION

In order to resolve the above-mentioned problems in the conventional payment methods, the present invention has its purpose in providing the method and device through which, in the event that certain accounts receivable arise and are confirmed due to a transaction partner's provision of goods, services, construction services or other providing acts, a financial institution receives the statement of specified and confirmed accounts receivable from the purchasing company through the computer data communication method, has the account transfer agreement authenticated by a certified electronic authentication institution for the purpose of utilizing such accounts receivable as the security for loans, and provides the loan in cash for the amount of the accounts receivable to the transaction partner until the due date of the purchase price payment (which is the same date as the conventional bill's expiration date). The present invention thus intends to prevent the chain bankruptcy, which is the ill effect of the use of bills, by providing cash for the accounts receivable early in the process.

In order to achieve the above-mentioned, purpose, the account receivable payment method based upon the on-line authenticated account transfer agreement comprises the steps of: (a) collecting the transaction partner's accounts receivable statements inputted through the computer data communication method by the purchasing company which has purchased goods or services from the transaction partner; (b) having the said colleted statements confirmed by the said transaction partner recorded in the said statements through the computer data communication method; (c) executing, through the computer data communication method, an agreement with the said transaction partner, under which the accounts receivable are transferred and the transaction partner's right to notify the account transfer is transferred (the “account transfer agreement”) and obtaining tie authentication from a certified electronic authentication institution; (d) the financial institution's making payment of the relevant loan amount in the event that the said transaction partner requests for a loan on the security of the accounts receivable by the input through the computer data communication method or otherwise in writing after obtaining the said authentication; (e) receiving the amount equivalent to the amount of the accounts receivable from the said purchasing company on the due date of the accounts receivable; and (f) checking to determine whether the loan has been provided to the said transaction partner or not and, if such loan has been provided, collecting the said received amount as the repayment for the loan or, if such loan has not been provided, transferring the received amount to the account of the transaction partner.

The present invention's accounts receivable payment device based upon the on-line authenticated account transfer agreement comprises: a means to collect accounts receivable statements of a transaction partner inputted by the purchasing company through the computer data communication method; a means to have the said collected statements confirmed by the relevant transaction partner recorded in the said statements through the computer data communication method; a means to execute an account transfer agreement with the said transaction partner through the computer data communication method and to obtain the authentication from a certified electronic authentication institution; an account transfer notification means to notify the said purchasing company of the said authenticated account transfer agreement; a means to receive the purchasing company's approval of the said account transfer through the computer data communication method; a means to receive, through the computer data communication method, the loan request from the said transaction partner for the amount desired by the transaction partner at the time desired by the transaction partner on the security of the accounts receivable; a means to pay the loan amount to the said transaction partner in the event that the said loan request is received from the transaction partner; a means to receive the amount equivalent to the accounts receivable from the said purchasing company on the due date of the accounts receivable; and a means to determine whether the loan has been provided to the said transaction partner and to collect the received amount as the repayment for the loan in the event that the loan has been provided or to transfer the received amount to the account of the transaction partner in the event that the loan has not been provided.

### BRIEF DESCRIPTION OF THE DRAWINGS

FIG. 1 is a diagram illustrating the flow of the processes conducted among the purchasing company, the transaction partner and the financial institution according to the present invention.

FIG. 2 is a diagram illustrating the structure of the payment device of the present invention.

FIG. 3 is a flow chart illustrating the operations conducted by the present invention's payment device.

### BEST MODE FOR CARRYING OUT THE INVENTION

Reference will now be made in detail to the preferred implementation of the present invention's accounts receivable payment method and device based upon the on-line authenticated account transfer agreement as illustrated in the accompanying drawings.

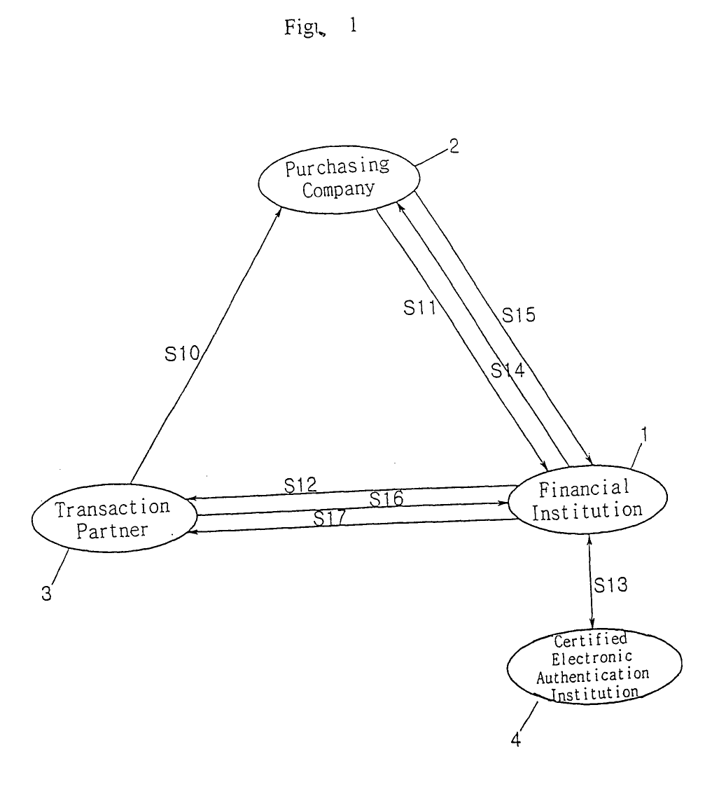

FIG. 1 is a diagram illustrating the flow of the processes conducted among the purchasing company, the transaction partner and the financial institution according to the present invention.

The transaction partner (3) provides the purchasing company (2) with goods, services or construction services and issues a tax invoice (S10). The said step S10 is conducted off-line.

The purchasing company (2) which received the goods, services or construction services transmits the statements of the accounts receivable for the relevant transaction partners to the said financial institution (1) in writing or by the computer data communication method through telecommunication networks such as the Internet, private circuit, PC banking using the PSTN, computer network using the VAN or other wireless Internet (S11).

Based upon the said accounts receivable statements for each transaction partner, the said financial institution (1) executes, on-line through the said computer data communication method, an agreement with the said transaction partner (3), under which the accounts receivable of the transaction partner (3) and the right to notify the account transfer are transferred from the transaction partner (3) (S12).

The said executed agreement is authenticated by the certified electronic authentication institution (4) (S13).

Pursuant to the account transfer notification right transfer agreement between the said financial institution (1) and the transaction partner (3), the financial institution (1) notifies the said purchasing company (2) of the account transfer by the content-certified notice as of the perfection date of the said account transfer agreement entered into with the said transaction partner (3) (S14). The said step S14 is conducted off-line. Furthermore, the said step S14 may be implemented by the computer data communication method using an electronic document from the certified electronic authentication institution (4) recognized as a document with a perfection date pursuant to the Electronic Signature Law or other relevant laws.

The purchasing company (2), which received the notice of the account transfer, confirms whether there is any prior right such as legal restriction on payment or encumbrance, distinguishes the accounts receivable, the transfer of which to the said financial institution (1) has been approved, from other accounts receivable subject to the ordinary payment without any related account transfer agreement, and then transmits the relevant data in writing or through the said computer data communication method (S15).

The data on the approval of the account transfer and the possibility of the loan concerning the account transfer agreement between the financial institution (1) and the transaction partner (3) are received from the said purchasing company (2) through the said telecommunication network or in writing. After receiving the said approval, the said financial institution (1) distinguishes the accounts receivable for which the said purchasing company (2) has transmitted the approval and for which the account transfer was approved, from other accounts receivable unrelated to any account transfer agreement and subject to the ordinary payment. The Financial institution (1) then notifies the distinguished result on the telecommunication network so that the transaction partner (3) may be advised thereof. After reviewing the notified data on the telecommunication network, the said transaction partner (3) requests through the said computer data communication method that the said financial institution (1) provide a certain amount of loan at a certain desired time on the security of the accounts receivable for which the approval was made (S16).

Upon the said loan request, the said financial institution (1) transfers, to the account designated by the said transaction partner (3), the cash in the amount of the purchase price requested to be provided to the transaction partner (3) (S17).

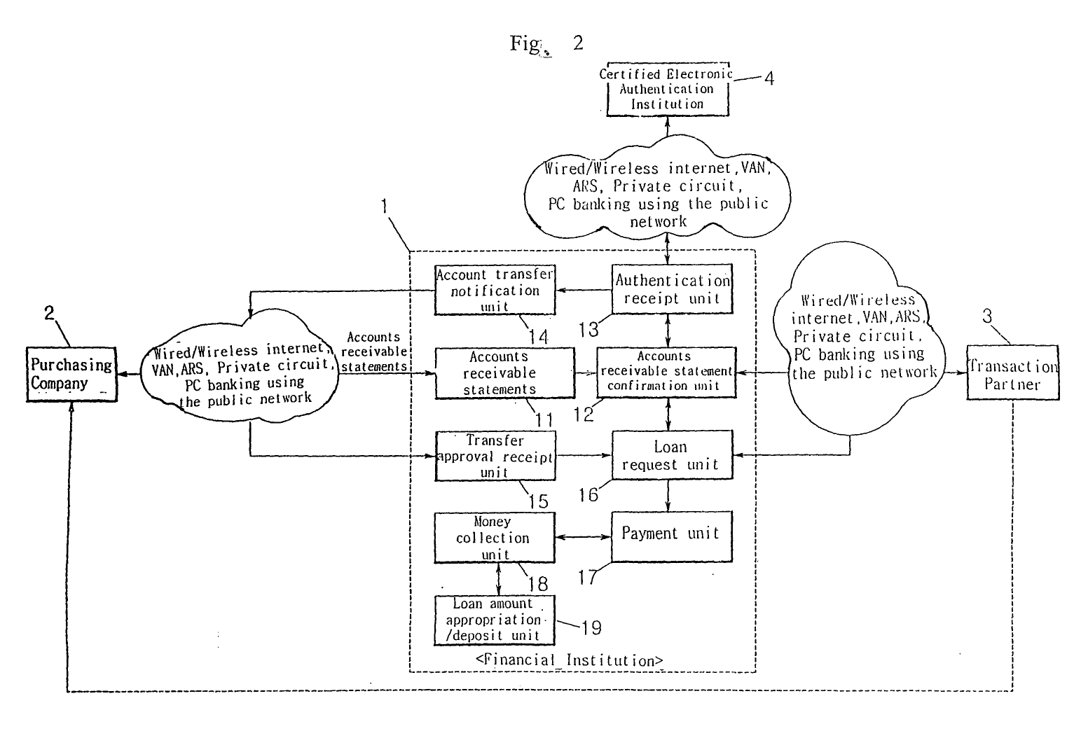

FIG. 2 is a diagram illustrating the structure of the payment device of the present invention. The present invention's payment device includes the financial institution (1) which makes the purchase price payment on behalf of the purchasing company (2), the purchasing company (2) which transacts with the said financial institution, the transaction partner (3) which is in the transactional relationship with the said purchasing company (2), and the certified electronic authentication institution (4) which authenticates the account transfer agreement between the said financial institution (1) and the said transaction partner (3) and the agreement under which the transaction partner (3)'s right to notify the account transfer is granted. The present invention's program and the device is applied to the said financial institution (1).

The said financial institution (1) comprises the accounts receivable statement collection unit (11), the accounts receivable statement confirmation unit (12), the authentication receipt unit (13), the transfer notification unit (14), the transfer approval receipt unit (15), the loan request unit (16), the payment unit (17), the money collection unit (18) and the loan amount appropriation/deposit unit (19).

The accounts receivable statement collection unit (11) collects the accounts receivable statements of the transaction partner (3) through the purchasing company (2) which received the goods, services or construction services from the transaction partner (3).

When the said statements are collected, the accounts receivable statement confirmation unit (12) confirms the said statements with the transaction partner (3) specified in the collected statements.

Simultaneously with or immediately upon the said statement confirmation unit (12)'s confirmation of the said statements with the transaction partner, the authentication receipt unit (13) obtains from the said certified electronic authentication institution (4) the authentication of the agreement under which the accounts receivable and the account transfer notification right of the transaction partner (3) are transferred from the said transaction partner (3). The authentication is obtained through the electronic authentication document or the authentication key assigned from the certified electronic authentication institution (4) recognized as a document with a perfection date pursuant to the Electronic Signature Law or other relevant laws.

The transfer notification unit (14) notifies the said purchasing company (2) of the account transfer based upon the said authenticated account transfer agreement. The said account transfer notification may be conducted off-line through the certified document with a fixed date such as a content-certified mail sent by the financial institution (1) on behalf of the transaction partner (3).

The transfer approval receipt unit (15) receives, from the said purchasing company notified of the account transfer, the account transfer approval and the information on whether the loan may be provided in connection with the account transfer agreement executed by the said financial institution (1) and the said transaction partner (3). The said account transfer approval and the information on the loan possibility may be received also in writing.

The loan request unit (16) takes, through the computer data communication method, the inputs of the said transaction partner (3)'s request for the loan, which is made possible through the said purchasing company (2)'s approval.

After the transfer approval receipt unit (15)'s confirmation and the transaction partner (3)'s input of the loan request into the said loan request unit (16), the payment unit (17) pays the amount of the loan to the transaction partner (3) as specified by the purchasing company (2).

After the loan is provided from the said payment unit (17), at the due date of the accounts receivable, the financial institution (1) collects the amount of the accounts receivable from the said purchasing company (2) through the money collection unit (18).

When the said money collection unit (18) receives the amount of the accounts receivable, the loan amount appropriation/deposit unit (19) checks whether the loan has been provided to the said transaction partner (3). If the loan has been provided, the collected money is accepted as the loan repayment. If there is any remaining balance in the account or if the loan has not been provided, the collected money is transferred to the account of the transaction partner (3).

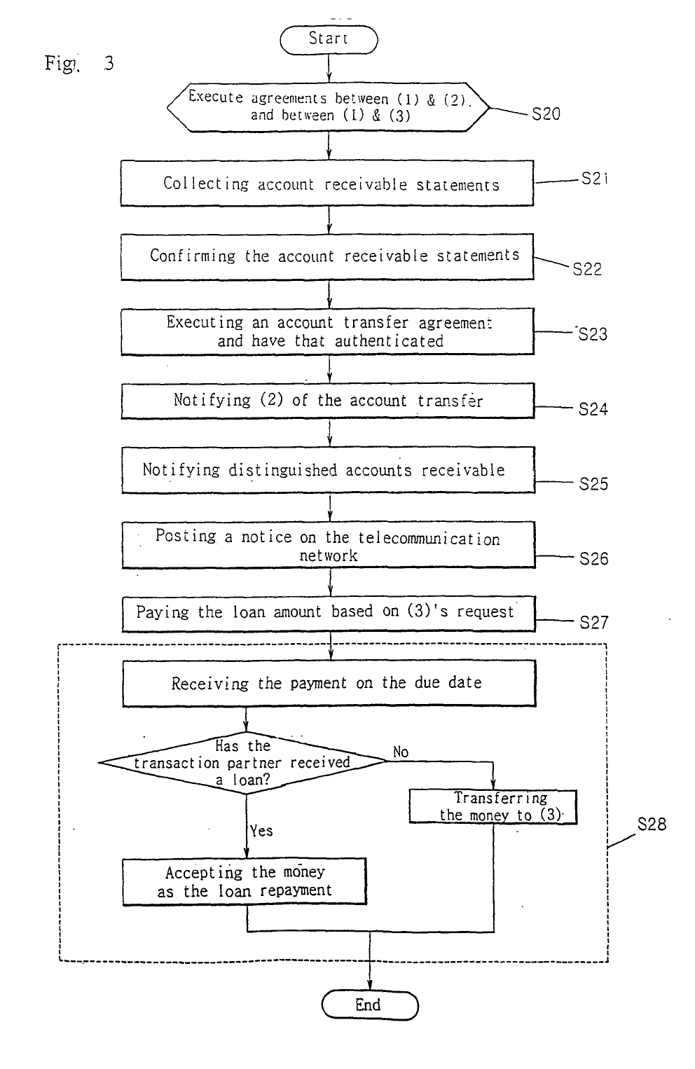

FIG. 3 is a flow chart illustrating the operations conducted by the present invention's payment device.

First, the financial institution (1) executes a loan agreement and an on-line security transfer agreement required for the said steps S12 and S13 with the transaction partner (3). Also, the financial institution (1) executes a separate general agreement with the purchasing company (2) for the facilitation of the loan provision procedures (S20).

In the foregoing state, if the transaction partner (3) provides goods, services or construction services to the said purchasing company (2), the said purchasing company (2) sends the account receivable statements for the relevant transaction partners (3) to the said financial institution (1) at the date set for the accounts receivable calculation (S21). The said accounts receivable statements summarize the accounts receivable owed during the period specified in the said general agreement.

While the accounts receivable statements may be transmitted in writing, the statements may alternatively be transmitted through the said computer data communication method, resultantly shortening the time required for such transmission.

After the said accounts receivable statements are transmitted, the accounts receivable statement collection unit (11) of the said financial institution (1) collects the said accounts receivable statements. Thereafter, the accounts receivable statement confirmation unit (12) confirms the relevant accounts receivable statements with the relevant transaction partner (3). Here, the confirmation may also be conducted either through writing or through the said computer data communication method or ARS method (S22).

The said financial institution (1), simultaneously with or immediately upon the said accounts receivable statement confirmation unit (12)'s confirmation of the accounts receivable statements with the transaction partner (3), executes the account transfer agreement and the agreement to receive the account transfer notification right from the transaction partner (3). After the said account transfer agreement is executed, the said financial institution (1) obtains the authentication of the agreement from the certified electronic authentication institution (4) (S23).

The authentication may be obtained through the electronic authentication document or an authentication key assigned from the certified electronic authentication institution (4) recognized as a document with a perfection date pursuant to the Electronic Signature Law or other relevant laws. Alternatively, the authentication may be obtained through a document with a certified date such as a content certified mail.

The account transfer agreement must be executed with respect to each account receivable arising upon a transaction partner (3)'s provision of goods or services to a purchasing company (2).

The notification of the said account transfer is notified to the said purchasing company (2) through the said computer data communication method or by a document with a certified date such as a content certified mail (S24). Through the said step S24, the transferred security that the financial institution (1) acquired in the said step S20 is perfected.

The said purchasing company (2), which has received the said account transfer notification, reviews the said account transfer notification to check whether there is any legal restriction on payment or if there is any problem. Thereafter, the purchasing company (2) distinguishes the accounts receivable, for which the approval of the account transfer has been granted based upon the account transfer agreement between the said financial institution (1) and the transaction partner (3) and thus on the security of which the loan may be provided, from other ordinary accounts receivable with respect to which no account transfer agreement has been executed. Then, the purchasing company (2) notifies the said financial institution (1) of the result of such distinction through the said computer data communication method or by a written document (S25).

Upon receiving from the said purchasing company (2) the approval of the account transfer based upon the account transfer agreement between the financial institution (1) and the transaction partner (3) and the information on the possibility of the loan provision, the said financial institution (1) posts a notice of the approval and the loan acceptability on the financial institution (1)'s telecommunication network or notifies the said transaction partner (3) of such information through the computer data communication method so that the transaction partner (3) may confirm such information on the approval and the acceptability (S26).

When the said transaction partner (3) which has confirmed the loan acceptability through the telecommunication network requests a loan for certain desired amount on the security of the accounts receivable at certain time through the said computer data communication method or the ARS method, the said financial institution (1) provides the loan to the transaction partner (3) as specified by the purchasing company (2) (S27).

Thereafter, the purchasing company (2) pays the financial institution (1) the amount of the accounts receivable at the due date. When the money collection unit (18) receives the amount of the accounts receivable, the loan amount appropriation/deposit unit (19) of the financial institution checks whether any loan has been provided to the relevant transaction partner (3). If it is determined that a loan has been provided, the collected money is accepted as the loan repayment. If there has been no loan provision and if the paid money is for the simple payment for the ordinary accounts receivable, the received money is transferred to the account of the transaction partner (3) (S28).

### INDUSTRIAL APPLICABILITY

As explained in detail in the foregoing, in order to prevent the chain bankruptcy caused by the conventional use of bills as a payment method for goods, services or construction services, the present invention enables banks and other financial institutions to provide loans for the payment for such goods, services or construction services through the network computer data communication method and ARS method. Thus, the present invention has the effect of preventing the drawback accompanied by the bill payment method. Furthermore, the present invention has the effect of eliminating the problem of the conventional difficulty in malting a successful defense against a third party's claim which arises after the execution of the account transfer agreement and before the account transfer notification.

Preferred embodiments of the present invention have been illustrated above for the purpose of presenting examples of the present invention's implementation. However, it is apparent to persons having ordinary skill in the relevant art that the present invention may be modified in various manners and implemented accordingly.

Such modified implementations must be deemed to be included in the extent of claims of the present invention attached hereto.

What is claimed is:

1. The accounts receivable payment method based upon the on-line authenticated account transfer agreement comprising the steps of:
(a) collecting the transaction partner's accounts receivable statements inputted through the computer data communication method by the purchasing company which has purchased goods or services from the transaction partner;
(b) having the said colleted statements confirmed by the said transaction partner recorded in the said statements through the computer data communication method;
(c) executing, through the computer data communication method, an agreement with the said transaction partner, under which the accounts receivable are transferred and the transaction partner's right to notify the account transfer is transferred (the “account transfer agreement”) and obtaining the authentication from a certified electronic authentication institution;
(d) the financial institution's making payment of the relevant loan amount in the event that the said transaction partner requests for a loan on the security of the accounts receivable by the input through the computer data communication method or otherwise in writing after obtaining the said authentication;
(e) receiving the amount equivalent to the amount of the accounts receivable from the said purchasing company on the due date of the accounts receivable; and
(f) checking to determine whether the loan has been provided to the said transaction partner or not and, if such loan has been provided, collecting the said received amount as the repayment for the loan or, if such loan has not been provided, transferring the received amount automatically to the account of the transaction partner.

2. The accounts receivable payment method based upon the on-line authenticated account transfer agreement according to claim 1, further comprising the following steps to be taken after the said step (c):
(g) the step of the financial institution's notifying the purchasing company of the account transfer based upon the account transfer agreement, on behalf of the transaction partner, by a document with a certified date such as a content-certified mail or by an electronic document of a certified authentication institution recognized as a certified date document pursuant to the Electronic Signature Law or other relevant laws;
(h) the step of receiving from the said purchasing company the unconditioned approval of the account transfer agreement executed by the financial institution and the transaction partner and the information on the possibility of the loan provision through the telecommunication network or in writing; and
(g) after the said approval is granted, the step of the financial institution's placing a notice on the telecommunication network of the purchasing company's approval and the loan possibility information so that the transaction partner may confirm such information.

3. The accounts receivable payment method based upon the on-line authenticated account transfer agreement according to claim 1, wherein the computer data communication method used to collect the accounts receivable statements in the said step (a) is the computer data communication method through telecommunication networks such as the Internet, private circuit, PC banking using the PSTN, computer network using the VAN or other wireless Internet.

4. The accounts receivable payment method based upon the on-line authenticated account transfer agreement according to claim 1, wherein the computer data communication method used to confirm the accounts receivable statements with the transaction partner in the said step (b) is the computer data communication method through telecommunication networks such as the Internet, private circuit, PC banking using the PSTN, computer network using the VAN or other wireless Internet.

5. The accounts receivable payment method based upon the on-line authenticated account transfer agreement according to claim 1, wherein the computer data communication method used to execute an account transfer agreement and to obtain the authentication of the account transfer agreement in the said step (c) is the computer data communication method through telecommunication networks such as the Internet, private circuit, PC banking using the PSTN, computer network using the VAN or other wireless Internet.

6. The accounts receivable payment method based upon the on-line authenticated account transfer agreement according to claim 1, wherein the computer data communication method used for the loan request in the said step (d) is the computer data communication method through telecommunication networks such as the Internet, private circuit, PC banking using the PSTN, computer network using the VAN or other wireless Internet.

7. The accounts receivable payment method based upon the on-line authenticated account transfer agreement according to claim 1, wherein the amount of accounts receivable is loaned until the due date of the accounts receivable after the confirmation of the loan request inputted in the said step (d).

8. The accounts receivable payment method based upon the on-line authenticated account transfer agreement according to claim 1, wherein the financial institution which pays the purchase price obtains the general collateral for future debts on the security of the accounts receivable arising between the transaction partner and the purchasing company which received goods, services or construction services, through the computer data communication method through telecommunication networks such as the Internet, private circuit, PC banking using the PSTN, computer network using the VAN or other wireless Internet.

9. The accounts receivable payment device based upon the on-line authenticated account transfer agreement comprising:
a means to collect accounts receivable statements of a transaction partner inputted by the purchasing company through the computer data communication method;
a means to have the said collected statements confirmed by the relevant transaction partner recorded in the said statements through the computer data communication method;
a means to execute an account transfer agreement with the said transaction partner and to obtain the authentication from a certified electronic authentication institution through the computer data communication method, after the said confirmation is conducted;
an account transfer notification means to notify the said purchasing company of the said authenticated account transfer agreement;
a means to receive the purchasing company's approval of the said account transfer through the computer data communication method;
a means to receive, through the computer data communication method, the loan request from the said transaction partner for the amount desired by the transaction partner at the time desired by the transaction partner on the security of the accounts receivable, after receiving the said approval;
a means to pay the loan amount to the said transaction partner when the said loan request is received from the transaction partner;
a means to receive the amount equivalent to the amount of accounts receivable from the said purchasing company on the due date of the accounts receivable; and
a means to determine whether the loan has been provided to the said transaction partner and to collect the received amount as the repayment for the loan in the event that the loan has been provided or to transfer the received amount automatically to the account of the transaction partner in the event that the loan has not been provided.

10. The accounts receivable payment device based upon the on-line authenticated account transfer agreement according to claim 9, wherein the computer data communication method used in the said means to collect accounts receivable statements is the computer data communication method through telecommunication networks such as the Internet, private circuit, PC banking using the PSTN, computer network using the VAN or other wireless Internet.

11. The accounts receivable payment device based upon the on-line authenticated account transfer agreement according to claim 9, wherein the computer data communication method used in the said means to have the statements confirmed with the transaction partner is the computer data communication method through telecommunication networks such as the Internet, private circuit, PC banking using the PSTN, computer network using the VAN or other wireless Internet.

12. The accounts receivable payment device based upon the on-line authenticated account transfer agreement according to claim 9, wherein the computer data communication method used in the said means to obtain the authentication is the computer data communication method through telecommunication networks such as the Internet, private circuit, PC banking using the PSTN, computer network using the VAN or other wireless Internet.

13. The accounts receivable payment device based upon the on-line authenticated account transfer agreement according to claim 9, wherein the computer data communication method used in the said means to pay the amount in the event that the payment request was received is the computer data communication method through telecommunication networks such as the Internet, private circuit, PC banking using the PSTN, computer network using the VAN or other wireless Internet.

14. The accounts receivable payment device based upon the on-line authenticated account transfer agreement according to claim 9, wherein the said means to pay the amount confirms the contents of the loan request when the loan request is inputted and then provides the requested loan until the due date of the accounts receivable.

15. The accounts receivable payment device based upon the on-line authenticated account transfer agreement according to claim 9, wherein the financial institution which pays the purchase price obtains the general collateral for future debts on the security of the accounts receivable arising between the transaction partner and the purchasing company which received goods, services or construction services, through the computer data communication method through telecommunication networks such as the Internet, private circuit, PC banking using the PSTN, computer network using the VAN or other wireless Internet.
